(19) United States
(12) Patent Application Publication
(10) Pub. No.: US 2018/0292985 A1
(43) Pub. Date: Oct. 11, 2018

(54) PROCESSING APPARATUS

(71) Applicant: DISCO CORPORATION, Tokyo (JP)

(72) Inventors: Hiroki Hidaka, Tokyo (JP); Kanae Hirata, Tokyo (JP); Katsuharu Negishi, Tokyo (JP); Hiroki Furusawa, Tokyo (JP)

(21) Appl. No.: 15/945,024

(22) Filed: Apr. 4, 2018

(30) Foreign Application Priority Data
Apr. 7, 2017 (JP) 2017-076645

(51) Int. Cl. G06F 3/0484; G06F 3/0488; G05B 19/18

(52) U.S. Cl. CPC G06F 3/04847; G06F 3/04883; G05B 2219/45044; G05B 2219/32128; G05B 19/182

(57) ABSTRACT

A processing apparatus includes a unit that is movable along one direction, a touch panel that displays an operation screen of the unit, a control unit that controls movement of the unit according to operation to the touch panel, and a movement axis that moves the unit forward and reversely along the one direction. A movement button that accepts a movement instruction to the unit is displayed on the touch panel. The control unit decides the movement direction of the movement axis based on a movement direction in which a finger that has pressed the movement button moves on a screen recognizes the movement speed of the finger that moves on the screen, and decides axis movement speed from the movement speed of the finger recognized by the finger movement speed recognizing section.

### BACKGROUND OF THE INVENTION

### Field of the Invention

The present invention relates to a processing apparatus having a touch panel.

### Description of the Related Art

In general, a processing apparatus that processes a workpiece such as a semiconductor wafer is configured to have plural movement axes. For example, in a cutting apparatus, an X-axis along which a chuck table that holds a workpiece is moved in a processing feed direction, a Z-axis along which a cutting blade is caused to move farther away from or closer to the chuck table, and a Y-axis along which the cutting blade is moved in an indexing direction are set. Moreover, in the cutting apparatus, besides the above-described X-axis, Y-axis, and Z-axis, various movement axes such as a lifting-lowering axis for lifting and lowering of a cassette stage and a conveyance axis along which the workpiece is conveyed between a cassette and the chuck table are set (for example, refer to Japanese Patent Laid-open No. 2006-108219).

In maintenance work of such a processing apparatus, the chuck table is moved in the X-direction and the cutting blade is moved in the Y-direction to evacuate units that are obstacles to the work and return the units to the original positions after the work. When the respective units are returned, the units are moved at low speed with a visual check of whether the units do not collide with each other. When the unit is evacuated, the movement position of the unit varies according to the work place. At a position distant from the target position, the unit is moved at high speed. When getting close to the target position, the unit is moved at low speed to be moved little by little with a visual check.

For this purpose, in the present processing apparatus, motion modes of high-speed movement and low-speed movement of the unit are set. Movement keys about which movement directions are symmetrical are displayed on a touch panel of the processing apparatus. Moreover, low-speed movement keys and high-speed movement keys are separately displayed as the movement keys and the motion mode of the movement axis is changed by pressing the movement key of different movement speed. That is, the following operation is possible. When a unit is comparatively distant from the target position, the operator presses the high-speed movement key on the touch panel to move the unit at high speed. When the unit comes close to the target position, the operator separates the finger from the high-speed movement key and presses the low-speed movement key to make switching to low-speed movement and bring the unit closer to the target position.

### SUMMARY OF THE INVENTION

In the above-described touch panel, low-speed movement and high-speed movement are stopped by separating a finger from the low-speed movement key and the high-speed movement key. For this reason, when switching between the low-speed movement and the high-speed movement is made, the movement keys different from each other are pressed and thus the movement keys on the touch panel need to be sought. Moreover, when a unit has passed through the target position, the movement key of the reverse direction needs to be pressed and thus the movement key of the reverse direction needs to be sought from the screen of the touch panel.

Thus, an object of the present invention is to provide a processing apparatus that can change the movement direction and movement speed of a unit by simple operation.

In accordance with an aspect of the present invention, there is provided a processing apparatus including a unit that is movable along one direction; a touch panel that displays an operation screen of the unit, a movement button that accepts a movement instruction to the unit being displayed on the touch panel; control means for controlling movement of the unit according to operation to the touch panel; and a movement axis that moves the unit forward and reversely along the one direction, in which the control means includes a movement direction deciding section that decides a movement direction of the movement axis based on a movement direction in which a finger that has pressed the movement button moves on a screen, a finger movement speed recognizing section that recognizes movement speed of the finger that moves on the screen, and an axis movement speed deciding section that decides axis movement speed from the movement speed of the finger recognized by the finger movement speed recognizing section.

According to this configuration, the movement direction of the unit is automatically decided based on the direction in which the finger that has pressed the movement button on the touch panel has moved on the screen. In addition, the movement speed of the unit is automatically decided based on the movement speed of the finger on the screen. Therefore, the movement direction and movement speed of the unit can be easily switched and the operability of the unit based on the touch panel is improved. Moreover, the movement direction of the unit is not instructed by a movement key, arrow key, or the like about which the movement direction has been decided, and the movement direction of the unit is automatically decided based on the direction in which the finger starts to move. Thus, the movement direction of the unit can be switched without visual check with the touch panel by the operator.

According to the present invention, the movement direction of the unit is decided from the direction in which the finger that has pressed the movement button on the touch panel has moved. In addition, the movement speed of the unit is decided from the movement speed of the finger on the screen. Therefore, the operability of the unit based on the touch panel can be improved.

The above and other objects, features and advantages of the present invention and the manner of realizing them will become more apparent, and the invention itself will best be understood from a study of the following description and appended claim with reference to the attached drawings showing a preferred embodiment of the invention.

### BRIEF DESCRIPTION OF THE DRAWINGS

FIG. 1 is an appearance perspective view of a cutting apparatus of an embodiment;

FIG. 2 is a perspective view of the inside of the cutting apparatus of the embodiment;

FIG. 3 is a diagram showing a display example of an axis motion screen of a comparative example;

FIG. 4 is a sectional schematic diagram of a touch panel of the embodiment;

FIG. 5 is a block diagram showing operation control for units in the embodiment;

FIG. 6 is a diagram showing a display example of the axis motion screen of the embodiment;

FIG. 7A to FIG. 7C are explanatory diagrams of an operation method of a movement axis in the embodiment;

FIG. 8A and FIG. 8B are explanatory diagrams of the operation method of the movement axis in the embodiment; and

FIG. 9 is a diagram showing a display example of the axis motion screen of a modification example.

### DETAILED DESCRIPTION OF THE PREFERRED EMBODIMENT

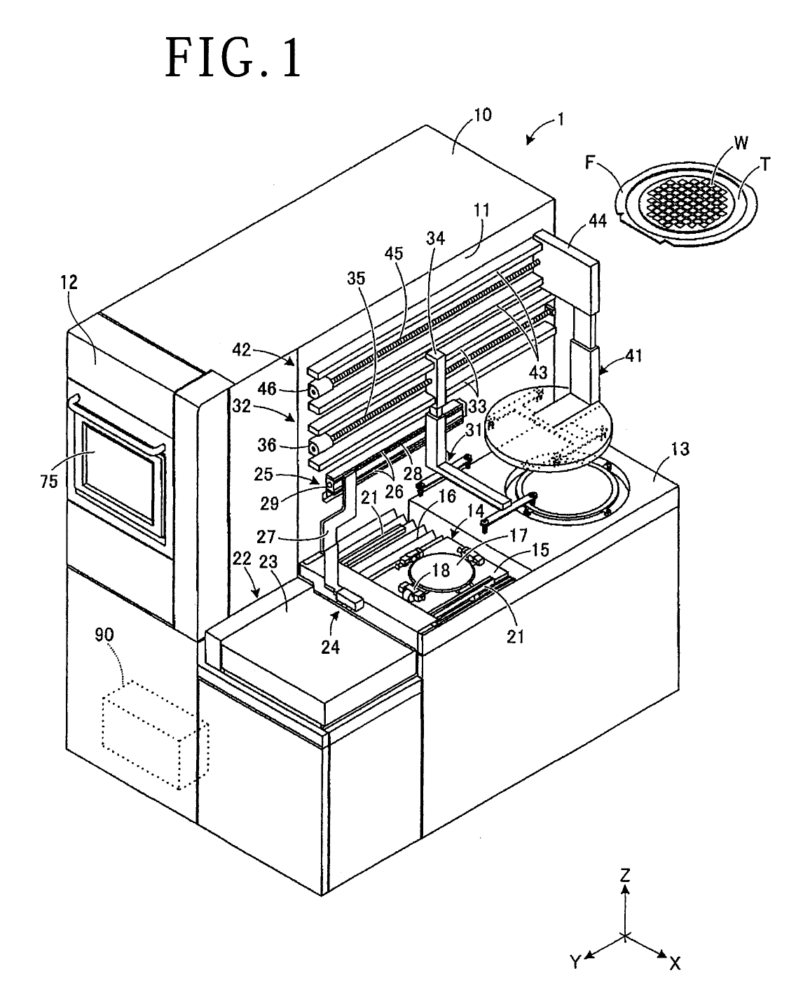

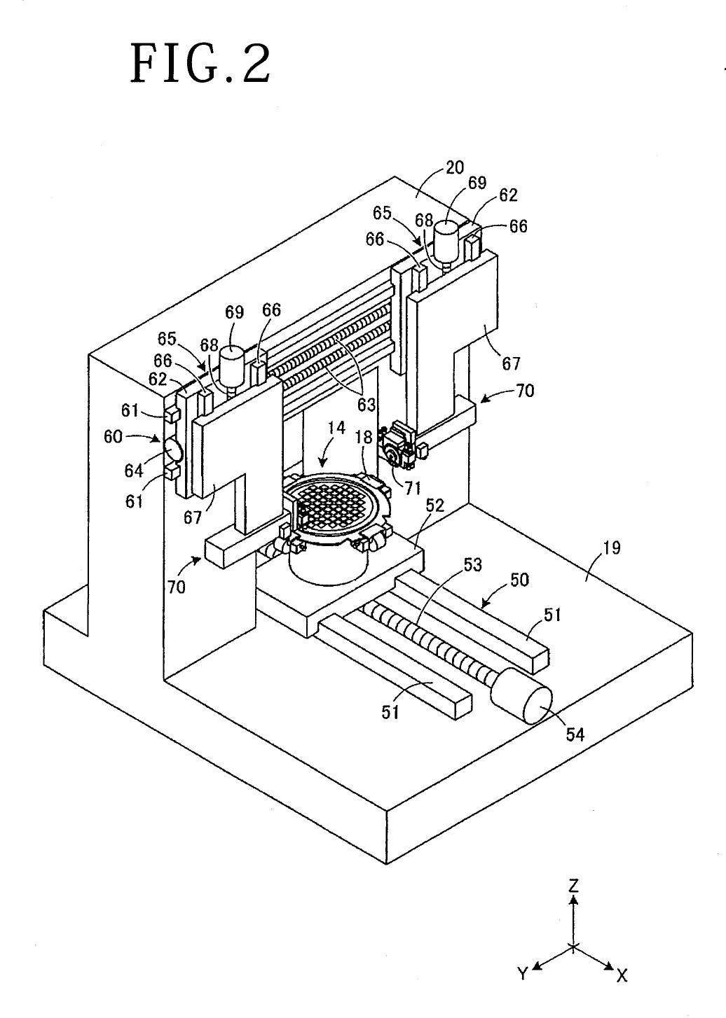

A cutting apparatus of the present embodiment will be described below with reference to the accompanying drawings. FIG. 1 is an appearance perspective view of the cutting apparatus of the present embodiment. FIG. 2 is a perspective view of the inside of the cutting apparatus of the present embodiment. The cutting apparatus is not limited to the configurations shown in FIG. 1 and FIG. 2. The cutting apparatus may have any configuration as long as it is an apparatus that cuts a workpiece by a cutting blade.

A cutting apparatus 1 is provided with a touch panel 75 that accepts operation by an operator and various kinds of processing conditions are set by the touch panel 75. The cutting apparatus 1 is configured to relatively move cutting blades 71 (see FIG. 2) and a workpiece W held by a chuck table 14 and cut the workpiece W on the chuck table 14 along planned dividing lines based on the setting conditions set by the touch panel 75. The front surface of the workpiece W is segmented into plural regions by the planned dividing lines in a lattice manner and various kinds of devices are formed in each of the regions obtained by the segmenting.

A dicing tape T is stuck to the back surface of the workpiece W and a ring frame F is stuck to the periphery of the dicing tape T. The workpiece W is carried in to the cutting apparatus 1 in the state of being supported by the ring frame F with the intermediary of the dicing tape T. It suffices for the workpiece W to be what becomes a processing target. For example, the workpiece W may be a semiconductor wafer or optical device wafer on which devices have been formed. Furthermore, the dicing tape T may be a die attach film (DAF) tape obtained by sticking a DAF to a tape base besides a normal adhesive tape obtained by applying an adhesive layer on a tape base.

The cutting apparatus 1 has a casing 10 that covers the processing space of cutting processing and has a rectangular parallelepiped shape and a support base 13 that is adjacent to the casing 10 and forms a waiting space and a cleaning space. The center of the upper surface of the support base 13 is opened to extend toward the inside of the casing 10 and this opening is covered by a moving plate 15 that can move together with the chuck table 14 and a waterproof cover 16 having an accordion shape. An X-axis movement mechanism 50 (see FIG. 2) that moves the chuck table 14 in the X-axis direction is provided under the waterproof cover 16. In FIG. 1, the state in which the chuck table 14 is moved to the outside of the casing 10 and is made to wait over the support base 13 is shown.

A holding surface 17 is formed in the chuck table 14 of a porous ceramic material and the workpiece W is sucked and held by a negative pressure generated through this holding surface 17. Four clamps 18 of an air-driven type are provided around the chuck table 14 and the ring frame F around the workpiece W is clamped and fixed from four sides by the respective clamps 18. A pair of centering guides 21 that extend along the Y-axis direction are provided over the chuck table 14. Through separation and approximation between the pair of centering guides 21 in the X-axis direction, the workpiece W is positioned in the X-axis direction relative to the chuck table 14.

On the support base 13, an elevator unit 22 on which a cassette is placed is provided adjacent to the chuck table 14. In the elevator unit 22, a stage 23 on which a cassette is placed is lifted and lowered and the loading/unloading position of the workpiece W in the cassette is adjusted in the height direction. A side surface 11 of the casing 10 is provided with a push-pull arm 24 that loads and unloads the workpiece W into and from a cassette while causing the pair of centering guides 21 to guide the ring frame F. Furthermore, the side surface 11 of the casing 10 is provided with a carry-in arm 31 and a carry-out arm 41 that convey the workpiece W between the pair of centering guides 21 and the chuck table 14.

The push-pull arm 24 is driven by a horizontal movement mechanism 25 disposed on the side surface 11 of the casing 10. The horizontal movement mechanism 25 has a pair of guide rails 26 that are disposed on the side surface 11 of the casing 10 and are parallel to the Y-axis direction and a slider 27 that is slidably set on the pair of guide rails 26 and is motor-driven. A nut part, which is not shown in the diagram, is formed on the back surface side of the slider 27 and a ball screw 28 is screwed to this nut part. A drive motor 29 joined to a one-end part of the ball screw 28 is rotationally driven and thereby the push-pull arm 24 executes push-pull action in the Y-axis direction along the pair of guide rails 26.

The carry-in arm 31 and the carry-out arm 41 are driven by horizontal movement mechanisms 32 and 42 disposed on the side surface 11 of the casing 10. The horizontal movement mechanisms 32 and 42 have pairs of guide rails 33 and 43 that are disposed on the side surface 11 of the casing 10 and are parallel to the Y-axis direction and sliders 34 and 44 that are slidably set on the pairs of guide rails 33 and 43 and are motor-driven. Nut parts, which are not shown in the diagram, are formed on the back surface side of the sliders 34 and 44 and ball screws 35 and 45 are screwed to these nut parts. Drive motors 36 and 46 joined to one-end parts of the ball screws 35 and 45 are rotationally driven and thereby the carry-in arm 31 and the carry-out arm 41 are conveyed and moved in the Y-axis direction along the pairs of guide rails 33 and 43.

As shown in FIG. 2, the X-axis movement mechanism 50 that moves the chuck table 14 in the X-axis direction is provided on a base 19 in the casing 10 and the support base 13 (see FIG. 1). The X-axis movement mechanism 50 has a pair of guide rails 51 that are disposed on the base 19 and are parallel to the X-axis direction and an X-axis table 52 that is slidably set on the pair of guide rails 51 and is motor-driven. A nut part, which is not shown in the diagram, is formed on the back surface side of the X-axis table 52 and a ball screw 53 is screwed to this nut part. A drive motor 54 joined to a one-end part of the ball screw 53 is rotationally driven and thereby the chuck table 14 is moved in the X-axis direction along the pair of guide rails 51.

A gate-shaped standing wall part 20 provided upright in such a manner as to straddle the movement path of the chuck table 14 is provided on the base 19. The standing wall part 20 is provided with a Y-axis movement mechanism 60 that moves cutting means 70 in the Y-axis direction and Z-axis movement mechanisms 65 that move the cutting means 70 in the Z-axis direction. The Y-axis movement mechanism 60 has a pair of guide rails 61 that are disposed on the front surface of the standing wall part 20 and are parallel to the Y-axis direction and Y-axis tables 62 slidably set on the pair of guide rails 61. The Z-axis movement mechanisms 65 each have a pair of guide rails 66 that are disposed on the Y-axis table 62 and are parallel to the Z-axis direction and a Z-axis table 67 slidably set on the pair of guide rails 66.

The cutting means 70 that cut the workpiece W are provided under the respective Z-axis tables 67. A nut part is formed on the back surface side of each of tables including the Y-axis tables 62 and the Z-axis tables 67 and ball screws 63 and 68 are screwed to these nut parts. Drive motors 64 and 69 are joined to one-end parts of the ball screws 63 for the Y-axis tables 62 and the ball screws 68 for the Z-axis tables 67, respectively. The respective ball screws 63 and 68 are rotationally driven by the drive motors 64 and 69. Thereby, each cutting means 70 is moved in the Y-axis direction along the guide rails 61 and each cutting means 70 is moved in the Z-axis direction along the guide rails 66.

The cutting blade 71 that is held by the chuck table 14 and cuts the workpiece W is rotatably mounted to a spindle of each cutting means 70. Each cutting blade 71 is shaped into a circular plate shape by binding diamond abrasive grains by a binding agent, for example. Returning back to FIG. 1, the touch panel 75 is set on a front surface 12 of the casing 10. On the display screen of the touch panel 75, operation screens of the respective units such as the chuck table 14 and the cutting means 70 and so forth are displayed besides a setting screen of various kinds of processing conditions. As the operation screen, for example, an axis motion screen with which each unit is manually operated at the time of maintenance is displayed.

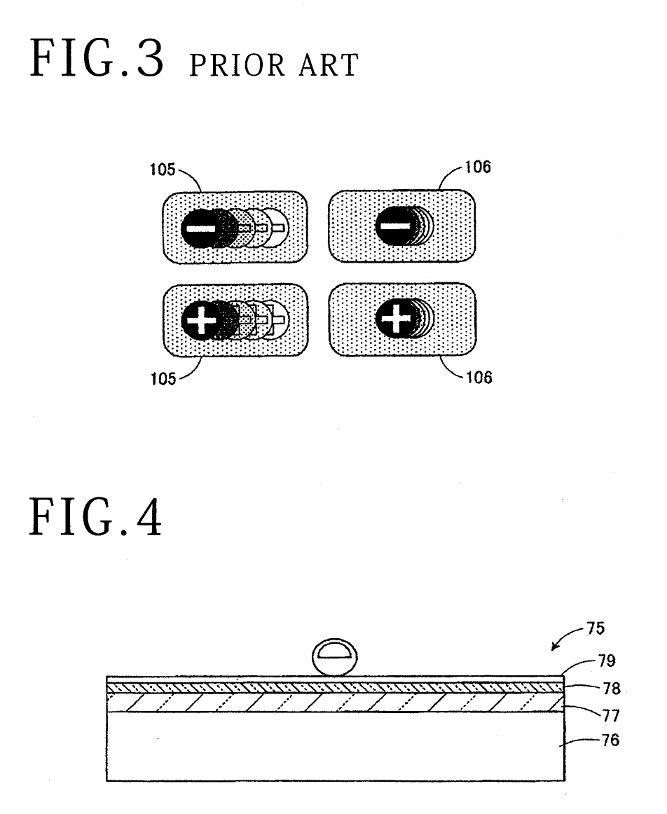

Incidentally, on a general axis motion screen like one shown in a comparative example of FIG. 3, high-speed movement keys 105 and low-speed movement keys 106 to instruct movement of a unit in forward and reverse directions and prescribe the movement speed are displayed. The movement direction and movement speed of the unit are decided through selection of the high-speed movement keys 105 and the low-speed movement keys 106. Thus, when the movement direction is changed and when the movement speed is changed, the high-speed movement key 105 and the low-speed movement key 106 are sought on the axis motion screen, which makes it difficult to execute fine adjustment of the motion of the unit.

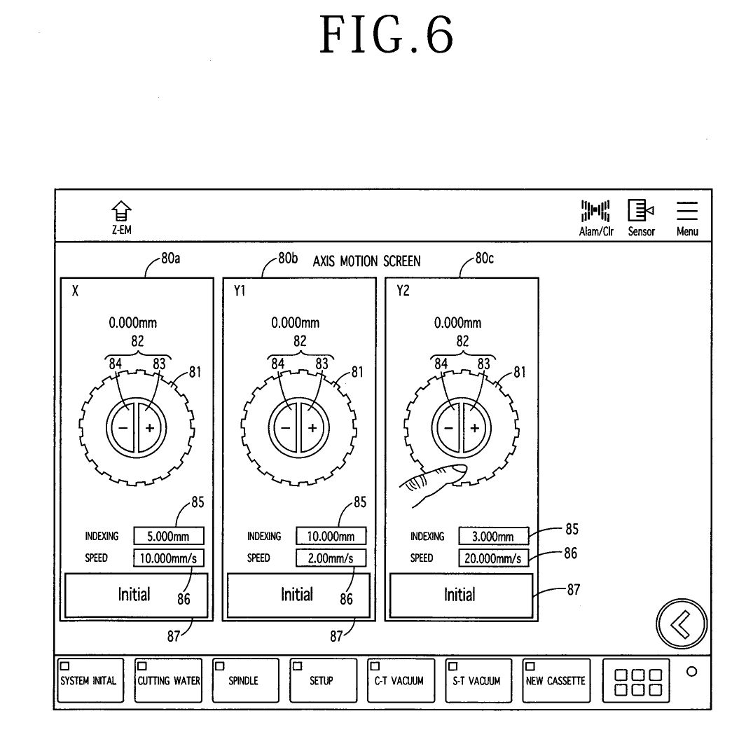

Therefore, in the present embodiment, movement buttons 81 (see FIG. 6) that accept an instruction of a unit are set in the axis motion screen. Furthermore, the movement direction of the unit is decided from the movement direction of a finger that has pressed the movement button 81 and the movement speed of the unit is decided from the movement speed of the finger. Due to this, the motion of the finger links to the motion of the unit. Therefore, the unit can be moved more intuitively and the operability of the touch panel 75 is improved. It is possible to rapidly move the unit toward the target position by such intuitive operation and accurately position the unit at the target position without seeking the movement key.

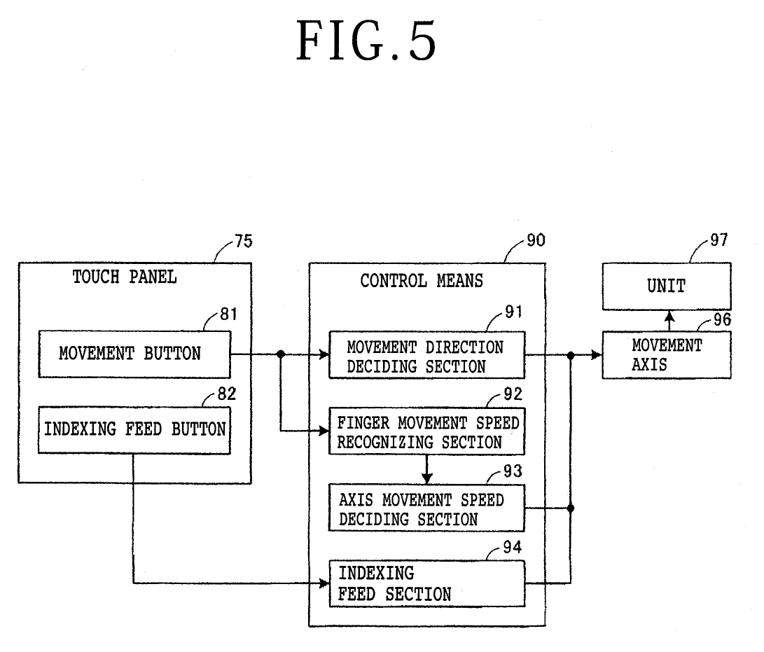

A control configuration for units will be described below with reference to FIG. 4 and FIG. 5. FIG. 4 is a sectional schematic diagram of the touch panel of the present embodiment. FIG. 5 is a block diagram showing operation control for units in the present embodiment. In the following description, explanation will be made in such a manner that the chuck table, the cutting means, the push-pull arm, the carry-in arm, and the carry-out arm are defined as units and the X-axis movement mechanism, the Y-axis movement mechanism, the Z-axis movement mechanism, and the horizontal movement mechanisms of the respective arms are defined as movement axes.

As shown in FIG. 4, the touch panel 75 is a touch panel of a so-called capacitive system and is configured by stacking a glass substrate 77, a transparent electrode film 78, and a protective film 79 over a liquid crystal panel 76. An axis motion screen (operation screen) of units 97 (see FIG. 5) is displayed on the liquid crystal panel 76 and it is possible to make setting input to the axis motion screen and operate movement axes 96 (see FIG. 5) by moving a finger tip over the panel upper surface. In this case, electrodes (not shown) are provided at four corners of the glass substrate 77 and a voltage is applied to the respective electrodes to generate a uniform electric field across the whole touch panel, and the coordinates of a finger tip are detected from change in the capacitance when the finger tip gets contact with the screen of the touch panel 75.

As shown in FIG. 5, the movement buttons 81 and indexing feed buttons 82 are displayed on the axis motion screen on the touch panel 75. The movement buttons 81 accept movement instructions to the movement axes 96 and are each used when the movement axis 96 (unit 97) is desired to be moved according to the motion of a finger. The indexing feed buttons 82 accept indexing feed (step feed) of the movement axes 96 (units 97) and are each used when the unit 97 is moved by a predetermined amount. Details of the axis motion screen will be described later. Control means 90 that controls movement of the unit 97 according to panel operation is connected to the touch panel 75.

The control means 90 is provided with a movement direction deciding section 91 that decides the movement direction of the movement axis 96 according to the movement direction of a finger that has pressed the movement button 81, a finger movement speed recognizing section 92 that recognizes the speed of the finger on the screen, and an axis movement speed deciding section 93 that decides the axis movement speed of the movement axis 96 from the movement speed of the finger. When a finger that has pressed the movement button 81 is slid, the movement direction deciding section 91 decides the movement direction of the movement axis 96 based on the movement direction of the finger. In this case, the position at which the finger has gotten contact with the movement button 81 first is deemed as the starting point and the movement direction of the movement axis 96 is decided depending on which of the clockwise direction (forward direction) and the anticlockwise direction (reverse direction) the finger moves in with respect to the starting point.

The finger movement speed recognizing section 92 recognizes the movement speed from the distance across which a finger has moved on the screen in a predetermined time. The movement speed of the finger is recognized to be low if the movement distance in the predetermined time is short, and the movement speed of the finger is recognized to be high if the movement distance in the predetermined time is long. The axis movement speed deciding section 93 decides the axis movement speed according to the movement speed of the finger recognized by the finger movement speed recognizing section 92. In this case, the axis movement speed according to the movement speed of the finger is decided with reference to a correspondence data table of the movement speed of the finger and the axis movement speed. For example, according to the movement speed of the finger, two stages of movement speed, low speed and high speed, are prepared as the axis movement speed.

Furthermore, the control means 90 is provided with an indexing feed section 94 that executes indexing feed of the unit 97 by the movement axis 96 through pressing of the indexing feed button 82 by a finger. When the indexing feed button 82 is pressed on the touch panel 75, the indexing feed section 94 drives the movement axis 96 to move the unit 97 along one direction by a predetermined indexing feed amount. That is, in the case of operating the movement axis 96 at the time of maintenance work or the like, it is possible to select two kinds of operation, direct feed operation with use of the movement button 81 and indexing feed operation with use of the indexing feed button 82.

As above, the units 97 joined to the movement axes 96 can be manually operated by operating the axis motion screen of the touch panel 75 with a finger. The respective units of the control means 90 are configured by processor, memory, and so forth that execute various kinds of processing. The memory is formed of one or plural storage media such as read only memory (ROM) and random access memory (RAM) according to the use purpose. In the memory, a program for drive control of the respective units of the apparatus and a program for display control are stored, for example. Furthermore, the control means 90 may be provided exclusively for the touch panel 75 separately from control of the whole of the cutting apparatus 1.

The axis motion screen will be described with reference to FIG. 6. FIG. 6 is a diagram showing a display example of the axis motion screen of the present embodiment. In FIG. 6, the X-axis represents an X-axis drive mechanism and the Y1-axis and the Y2-axis represent a pair of Y-axis drive mechanisms. Furthermore, with FIG. 6, the description will be made by using numerals in FIG. 2 as appropriate.

As shown in FIG. 6, in the axis motion screen, an operation region 80a of the X-axis of the chuck table 14, an operation region 80b of the Y1-axis of one cutting means 70, and an operation region 80c of the Y2-axis of the other cutting means 70 are set from the left of the diagram. The indexing feed buttons 82 are displayed at the central parts of the operation regions 80a, 80b, and 80c of the X-, Y1-, and Y2-axes. The indexing feed buttons 82 are each composed of a positive button 83 and a negative button 84 having a semicircular shape. Indexing feed of the X-axis, the Y1-axis, and the Y2-axis in the forward direction is executed by the positive buttons 83 and indexing feed of the X-axis, the Y1-axis, and the Y2-axis in the reverse direction is executed by the negative buttons 84.

The movement buttons 81 having a ring shape are displayed around the indexing feed buttons 82. A finger is moved while the movement button 81 remains pressed with the finger. Thereby, movement of the X-axis, the Y1-axis, or the Y2-axis is executed according to the movement of the finger. The position at which the finger has gotten contact with the movement button 81 first is deemed as the starting point and the movement direction (forward or reverse direction) of the X-axis, the Y1-axis, or the Y2-axis is decided depending on which direction of the clockwise direction (forward direction) and the anticlockwise direction (reverse direction) the finger starts to move in with respect to the center of the movement button 81. In the example of the diagram, when a finger starts to move in the clockwise direction, the X-axis, the Y1-axis, or the Y2-axis is moved in the forward direction. When the finger starts to move in the anticlockwise direction, the X-axis, the Y1-axis, or the Y2-axis is moved in the reverse direction. As described later in detail, the movement direction and the movement distance are recognized from the coordinates of at least three points on the locus of the finger that has moved on the screen in a predetermined time.

Moreover, the movement speed of the finger is obtained from the movement distance in the predetermined time and the movement speed of the X-axis, the Y1-axis, or the Y2-axis is decided according to the movement speed of the finger. For example, the touch panel 75 recognizes the coordinates of the place pressed with the finger and the movement distance of the finger is obtained based on the locus along which the finger has moved in the predetermined time. Then, switching is made between high-speed movement and low-speed movement of the X-axis, the Y1-axis, or the Y2-axis according to whether or not this movement distance is equal to or longer than a reference distance. The high-speed movement corresponds with the indexing feed speed and the low-speed movement is set to 1/10 of the indexing feed speed. Then, when the finger is separated from the movement button 81, the movement direction and movement speed of the X-axis, the Y1-axis, or the Y2-axis are reset.

When the movement button 81 is pressed, input to another button becomes unacceptable until the finger is separated from the screen (operation surface) of the touch panel 75. Therefore, even when a finger is slid in the state in which the finger presses the movement button 81 and the finger gets contact with the indexing feed button 82, indexing feed of the X-axis, the Y1-axis, or the Y2-axis is not executed and erroneous operation is prevented. Furthermore, once the movement button 81 is pressed with a finger, the whole screen of the touch panel 75 functions as the operation surface. Thus, even when the finger slid on the screen gets out of the ring-shaped region of the movement button 81, the X-axis, the Y1-axis, or the Y2-axis can be moved until the finger is separated from the screen of the touch panel 75. That is, the movement direction does not change until the finger is separated from the screen and the movement speed is changed in association with the movement speed of the finger.

Input cells 85 and 86 and origin return buttons 87 are set at the lower parts of the respective operation regions 80a, 80b, and 80c. The indexing feed amounts of the X-axis, the Y1-axis, and the Y2-axis are set in the input cells 85 and the movement speeds at the time of high-speed movement of the X-axis, the Y1-axis, and the Y2-axis are set in the input cells 86. Through pressing of the origin return buttons 87, return to the initial standby position is executed regarding the X-axis, the Y1-axis, and the Y2-axis. As above, by moving the X-axis, the Y1-axis, and the Y2-axis in association with the motion of a finger on the axis motion screen, the chuck table 14 and the pair of cutting means 70 can be intuitively moved forward and reversely along one direction.

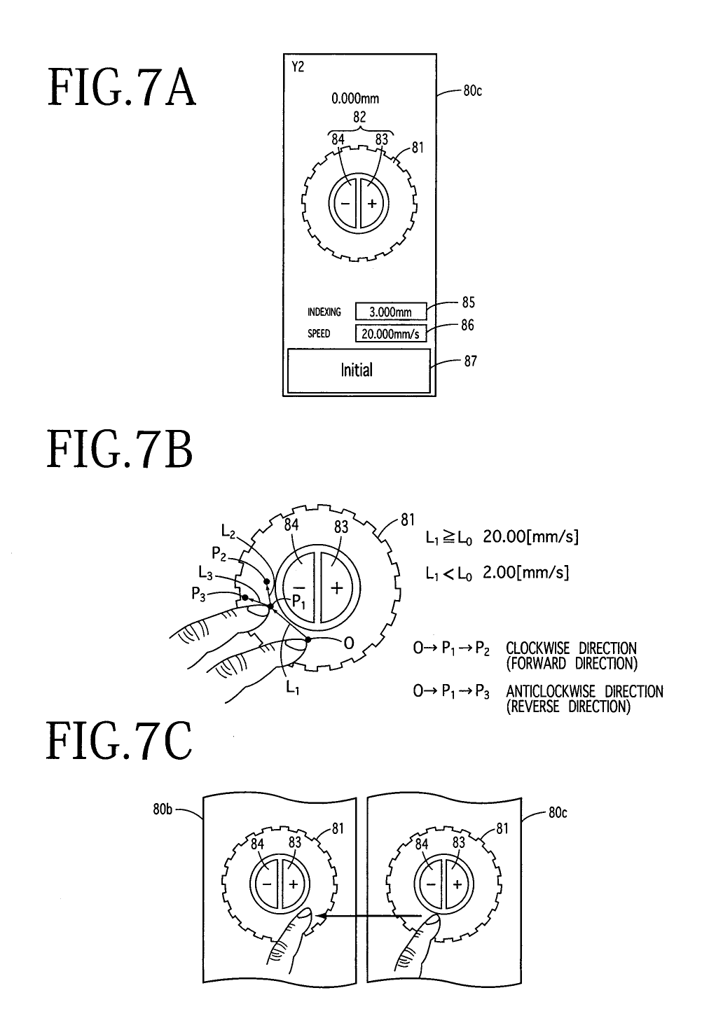

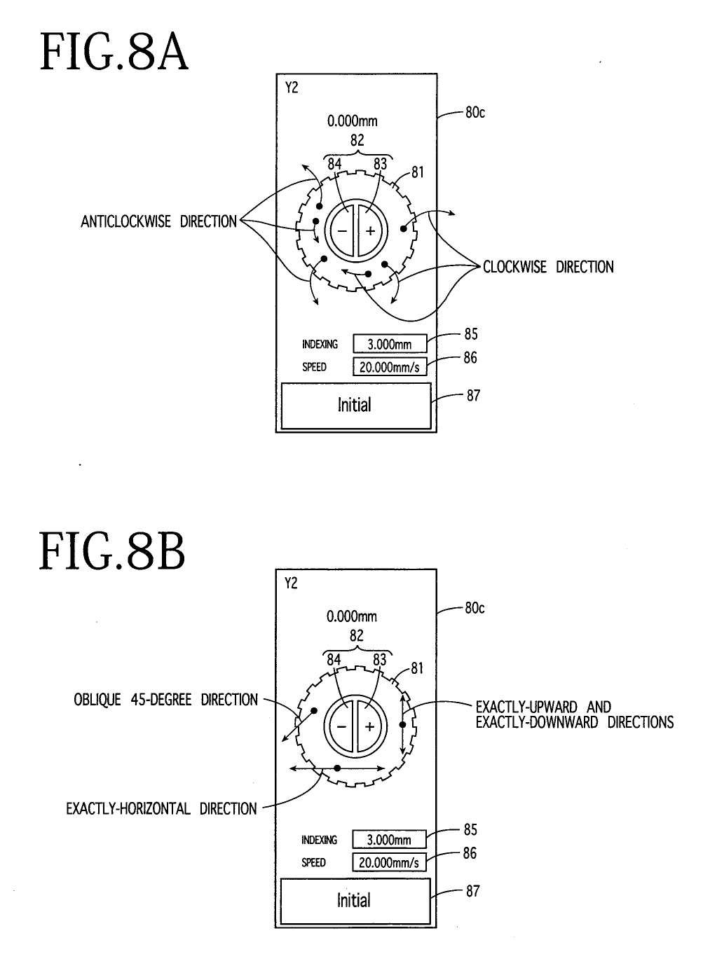

An operation method of the movement axis by use of the touch panel will be described with reference to FIG. 7A to FIG. 7C and FIG. 8A and FIG. 8B. FIG. 7A to FIG. 7C and FIG. 8A and FIG. 8B are explanatory diagrams of the operation method of the movement axis in the present embodiment. Although one example of operating the Y2-axis will be described with reference to FIG. 7A to FIG. 7C and FIG. 8A and FIG. 8B, the same applies also to the X-axis and the Y1-axis.

As shown in FIG. 7A, in the case of indexing feed operation, either the positive button 83 or the negative button 84 of the indexing feed button 82 of the Y2-axis is selected with a finger. For example, when the negative button 84 of the indexing feed button 82 is pressed with the finger, indexing feed of the Y2-axis in the negative direction (reverse direction) is executed. At this time, 3.000 [mm] has been input to the input cell 85 for indexing feed and 20.00 [mm/second] has been input to the input cell 86 for movement speed. Thus, every time the negative button 84 is pressed with the finger, indexing feed of the Y2-axis is executed by 3.000 [mm] at movement speed of 20.00 [mm/second].

As shown in FIG. 7B, in the case of direct feed operation, an arbitrary position on the ring-shaped movement button 81 of the Y2-axis is pressed with a finger and the finger is slid with the screen remaining pressed. At this time, the position at which the finger has pressed the movement button 81 first becomes a starting point O and the movement direction of the Y2-axis is decided depending on which direction of the clockwise direction and the anticlockwise direction the movement direction (movement locus) of the finger in a predetermined time becomes on the basis of the starting point O. That is, the movement direction is decided from the coordinates of at least three points in the predetermined time. For example, in FIG. 7B, the movement direction is recognized as the clockwise direction (forward direction) when the finger is slid in order of starting point O, point P₁, and point P₂, and is recognized as the anticlockwise direction (reverse direction) when the finger is slid in order of starting point O, point P₁, and point P₃.

Furthermore, for example, as shown in FIG. 8A, even when the finger that has pressed the movement button 81 gets out of the movement button 81, the movement direction is recognized based on the locus of the finger that has moved on the screen. Moreover, if the direction in which the finger that has pressed the movement button 81 is slid is an oblique 45° direction, exactly-horizontal (0°) direction, or exactly-upward or exactly-downward (90°) direction as shown in FIG. 8B, it is impossible to determine the direction of the slid finger as the clockwise direction or the anticlockwise direction and therefore the Y2-axis does not operate.

In addition, as shown in FIG. 7B, the movement distance across which the finger has been moved in a predetermined time (for example, 300 [millisecond]) is obtained. Then, movement distance L₁ and reference distance L₀ are compared and the movement speed of the Y2-axis is set. If the movement distance L₁ is equal to or longer than the reference distance L₀, it is deemed that the speed of the finger is high, and the movement speed of the Y2-axis is set to 20.00 [mm/second] in the high-speed movement. If the movement distance L₁ is shorter than the reference distance L₀, it is deemed that the speed of the finger is low, and the movement speed of the Y2-axis is set to 2.00 [mm/second] in the low-speed movement. Then, when the finger is separated from the axis motion screen, the movement direction and movement speed of the Y2-axis are reset.

Furthermore, the speed may be decided from movement distance L₂ and movement distance L₃ if the movement distance L₂ and the movement distance L₃ are shorter than the movement distance L₁, the movement distance L₁ is longer than the reference distance L₀ and the movement distance L₂ and the movement distance L₃ are shorter than the reference distance L₀. For example, if a finger moves in order of starting point O, point P₁, and point P₂, the movement direction of the finger is recognized as the clockwise direction and, when the axis movement is started, 2.00 mm/second as the speed of the low-speed movement is set because the movement distance L₂ is shorter than the reference distance L₀.

As shown in FIG. 7C or FIG. 8A, the whole of the axis motion screen becomes the operation surface at the timing when the movement button 81 is pressed. Thus, the movement direction and movement speed of the Y2-axis can be decided even when the finger moves to the outside of the ring-shaped region of the movement button 81. Furthermore, at the timing when the movement button 81 is pressed with a finger, input to another button on the axis motion screen becomes unacceptable. Therefore, in the direct feed operation of the Y2-axis, indexing feed operation of the Y2-axis and operation to the X-axis and the Y1-axis are not executed. When a return to the origin position is made regarding the Y2-axis, the origin return button 87 (see FIG. 7A) is pressed and the Y2-axis is returned to the initial state before the start of the movement.

As described above, in the cutting apparatus 1 of the present embodiment, the movement direction of the unit is automatically decided based on the locus along which a finger that has pressed the movement button 81 on the touch panel 75 has moved on the screen in the predetermined time. In addition, the movement speed of the unit is automatically decided based on the movement speed of the finger on the screen. Due to this, the motion of the finger tip links to the motion of the unit. Therefore, the unit can be moved more intuitively, and the movement direction and movement speed of the unit are easily switched and the operability of the unit based on the touch panel is improved.

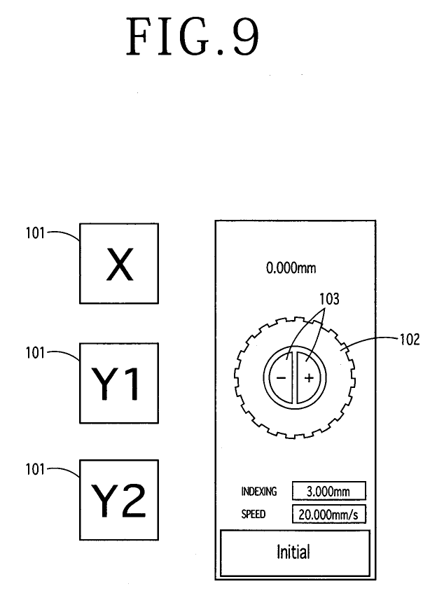

In the present embodiment, the operation regions of the X-axis, the Y1-axis, and the Y2-axis are set in the axis motion screen. However, the present invention is not limited to this configuration. For example, as shown in FIG. 9, axis selection buttons 101 used for selection of the X-axis, the Y1-axis, and the Y2-axis may be provided on the axis motion screen and an indexing feed button 103 and a movement button 102 common to the X-axis, the Y1-axis, and the Y2-axis may be set. In this case, the movement axis of the operation target is selected by pressing the axis selection button 101 and the selected movement axis is moved by the indexing feed button 103 and the movement button 102.

Furthermore, in the present embodiment, the configuration is employed in which the finger movement speed recognizing section recognizes the movement speed of a finger from the movement distance in the predetermined time. However, the present invention is not limited to this configuration. It suffices for the finger movement speed recognizing section to have a configuration to recognize the speed of a finger that moves on the screen, and the finger movement speed recognizing section may recognize the movement speed of a finger from the time it takes for the finger to move across a predetermined distance.

Moreover, in the present embodiment, the configuration is employed in which the axis movement speed deciding section decides the axis movement speed from the movement speed of a finger by using the correspondence data table of the movement speed of the finger and the axis movement speed. However, the present invention is not limited to this configuration. It suffices for the axis movement speed deciding section to decide the axis movement speed from the correspondence relationship between the movement speed of the finger and the axis movement speed, and the axis movement speed deciding section may store the movement speed of the finger and the axis movement speed in a graph format.

In addition, in the present embodiment, the configuration is employed in which the axis movement speed deciding section varies the axis movement speed to two stages, high speed and low speed. However, the present invention is not limited to this configuration. The axis movement speed deciding section may vary the axis movement speed to three or more stages. Furthermore, the axis movement speed deciding section may set the axis movement speed to speed made proportional to the movement speed of the finger.

Furthermore, in the present embodiment, the touch panel of the capacitive system (surface capacitive system) is exemplified. However, the present invention is not limited to this configuration. It suffices for the touch panel to be capable of displaying the operation screen of the unit. For example, a touch panel of any of a resistive film system, projected capacitive system, ultrasonic surface acoustic wave system, optical system, or electromagnetic induction system may be used.

Moreover, in the present embodiment, the description is made with exemplification of the cutting apparatus that cuts a workpiece as the processing apparatus. However, the present invention is not limited to this configuration. The present invention can be applied to other processing apparatuses having a touch panel. For example, the present invention may be applied when other processing apparatuses such as grinding apparatus, polishing apparatus, laser processing apparatus, plasma etching apparatus, edge trimming apparatus, expanding apparatus, breaking apparatus, and cluster apparatus obtained by combining them are caused to move a movement axis as long as these processing apparatuses are each processing apparatus having a touch panel.

Therefore, although the chuck table, the cutting means, the push-pull arm, the carry-in arm, and the carry-out arm are exemplified as the units in the present embodiment, the present invention is not limited to this configuration. It suffices for the units to have a configuration that enables movement along one direction, and the units may be units such as various kinds of processing means, tables, and conveying means used in a grinding apparatus, a polishing apparatus, a laser processing apparatus, a plasma etching apparatus, an edge trimming apparatus, an expanding apparatus, a breaking apparatus, and a cluster apparatus, for example.

Moreover, in the present embodiment, the X-axis movement mechanism, the Y-axis movement mechanism, the Z-axis movement mechanism, and the horizontal movement mechanisms of the respective arms are exemplified as the movement axes. However, the present invention is not limited to this configuration. It suffices for the movement axes to have a configuration that moves the unit forward and reversely along one direction, and the movement axes may be an X-axis movement mechanism, a Y-axis movement mechanism, a Z-axis movement mechanism, and a horizontal movement mechanism used in a grinding apparatus, a polishing apparatus, a laser processing apparatus, a plasma etching apparatus, an edge trimming apparatus, an expanding apparatus, a breaking apparatus, and a cluster apparatus. Furthermore, the movement axes are not limited to movement mechanisms of a feed screw system. It suffices for the movement axes to be movement mechanisms of a direct acting system, and the movement axes may be movement mechanisms of a linear motor system, for example.

Furthermore, as the processing target, various kinds of works such as semiconductor device wafer, optical device wafer, package substrate, semiconductor substrate, inorganic material substrate, oxide wafer, green ceramic substrate, and piezoelectric substrate may be used, for example, according to the kind of processing. As the semiconductor device wafer, a silicon wafer or compound semiconductor wafer after device forming may be used. As the optical device wafer, a sapphire wafer or silicon carbide wafer after device forming may be used. Furthermore, a chip size package (CSP) substrate may be used as the package substrate. Silicon, gallium arsenide, or the like may be used as the semiconductor substrate and sapphire, ceramics, glass, or the like may be used as the inorganic material substrate. Moreover, as the oxide wafer, lithium tantalate or lithium niobate after device forming or before device forming may be used.

Moreover, although the embodiment of the present invention is described, what are obtained by wholly or partly combining the above-described embodiment and modification examples may be employed as other embodiments of the present invention.

Furthermore, embodiments of the present invention are not limited to the above-described embodiment and modification examples and may be variously changed, replaced, and modified without departing from the gist of technical ideas of the present invention. Moreover, if technical ideas of the present invention can be implemented in another way by advancement in technique or another technique that is derivative, the present invention may be carried out by using the method. Therefore, the scope of the claim covers all embodiments that can be included in the range of technical ideas of the present invention.

Moreover, although the configuration in which the present invention is applied to a cutting apparatus is described in the present embodiment, it is also possible to apply the present invention to another apparatus that drives a direct acting mechanism by a touch panel. As described above, the present invention has an effect that the movement direction and movement speed of a unit can be changed by simple operation, and is particularly useful for a cutting apparatus that cuts a workpiece.

The present invention is not limited to the details of the above described preferred embodiment. The scope of the invention is defined by the appended claim and all changes and modifications as fall within the equivalence of the scope of the claim are therefore to be embraced by the invention.

What is claimed is:

1. A processing apparatus comprising:
a unit that is movable along one direction;
a touch panel that displays an operation screen of the unit, a movement button that accepts a movement instruction to the unit being displayed on the touch panel;
control means for controlling movement of the unit according to operation to the touch panel; and
a movement axis that moves the unit forward and reversely along the one direction,
wherein the control means includes
a movement direction deciding section that decides a movement direction of the movement axis based on a movement direction in which a finger that has pressed the movement button moves on a screen,
a finger movement speed recognizing section that recognizes movement speed of the finger that moves on the screen, and
an axis movement speed deciding section that decides axis movement speed from the movement speed of the finger recognized by the finger movement speed recognizing section.
